(19) United States
(12) Patent Application Publication
(10) Pub. No.: US 2011/0131088 A1
(43) Pub. Date: Jun. 2, 2011

(54) SHOPPING SUPPORTING APPARATUS AND METHOD

(75) Inventors: Yoshiaki Oe, Shizuoka (JP); Yun Wang, Kanagawa (JP); Tsuyoshi Gotanda, Tokyo (JP); Shiomi Matsui, Shizuoka (JP); Yoshimi Sato, Shizuoka (JP)

(73) Assignee: TOSHIBA TEC KABUSHIKI KAISHA, Tokyo (JP)

(21) Appl. No.: 12/953,653

(22) Filed: Nov. 24, 2010

(30) Foreign Application Priority Data
Nov. 30, 2009 (JP) 2009-272556

(51) Int. Cl. G06Q 30/00

(52) U.S. Cl. 705/14.25; 705/26.8

(57) ABSTRACT

According to one embodiment, a purchase file stores, by commodity, as information concerning purchase-desired commodities specified by a specifying unit, at least the numbers of purchase-planned items and purchase-planned amounts of the commodities. A privilege granting unit grants a privilege to the purchase of the purchase-desired commodities when a total of a total number of purchased items of the purchase-desired commodities obtained from a purchase-results storing unit, which stores information concerning commodities already purchased by a customer, and the numbers of purchase-planned items of the same commodities stored in the purchase file or a total of a total amount of purchased items of the purchase-desired commodities obtained from the purchase-results storing unit and purchase-planned amounts of the same commodities stored in the purchase file is equal to or larger than a threshold. A privilege display unit displays information concerning the privilege granted by the privilege granting unit.

### CROSS-REFERENCE TO RELATED APPLICATIONS

This application is based upon and claims the benefit of priority from Japanese Patent Application No. 2009-272556, filed on Nov. 30, 2009, the entire contents of which are incorporated herein by reference.

### FIELD

Embodiments described herein relate generally to a portable shopping supporting apparatus and a shopping supporting method for supporting shopping of a customer who visits a retail store.

### BACKGROUND

A portable shopping supporting apparatus attached to a shopping cart in a store is known. This apparatus includes a barcode reader and specifies a commodity according to barcode information of the commodity read by the barcode reader. When the commodity is specified, the apparatus acquires commodity information of the commodity from a server and causes a display unit to display the commodity information. Therefore, a customer who uses the shopping cart can easily check information concerning a commodity, which the customer is about to purchase, by causing the barcode reader to read a barcode of the commodity.

There is known a sales system for cumulatively recording, every time a customer settles an account for a commodity purchased in a retail store, an amount or the number of items of the purchased commodity in a card carried by the customer and granting a privilege such as a discount to the customer when a total purchase amount or a total number of purchased items of a specific commodity reaches a fixed value. If the retail store introduces such a sales system, a frequency of visit to the store by the customer increases. Therefore, an increase in sales can be expected.

However, in the past, it is unknown whether a privilege is granted to a customer unless the customer settles an account for a commodity that the customer is about to purchase. For example, if it is possible to notify a customer, who is about to purchase a commodity in a selling floor, that a privilege is granted when the customer purchases the commodity, eagerness to buy of the customer can be increased. This leads to sales promotion.

### BRIEF DESCRIPTION OF THE DRAWINGS

FIG. 1 is a diagram of a system according to a first embodiment;

FIG. 2 is a schematic diagram of data structure of a commodity data record stored in a commodity database in the first embodiment;

FIG. 3 is a schematic diagram of an example of a discount pattern table of a store server in the first embodiment;

FIG. 4 is a schematic diagram of data structure of a member data record stored in a member database in the first embodiment;

FIG. 5 is a block diagram of a main part configuration of a radio communication terminal in the first embodiment;

FIG. 6 is a schematic diagram of a main memory area formed in a RAM of the radio communication terminal in the first embodiment;

FIG. 7 is a block diagram of a main part configuration of a POS terminal in the first embodiment;

FIG. 8 is a flowchart for explaining main processing steps executed by a CPU of the radio communication terminal in the first embodiment;

FIG. 9 is a flowchart for specifically explaining a discount determination processing step in the processing steps shown in FIG. 8;

FIG. 10 is a flowchart for specifically explaining a commodity return processing step in the processing steps shown in FIG. 8;

FIG. 11 is a diagram of a display example of a shopping supporting screen displayed on a touch panel of the radio communication terminal in the first embodiment;

FIG. 12 is a diagram of a display example of a purchased commodity information screen displayed on the touch panel of the radio communication terminal in the first embodiment;

FIG. 13 is a diagram of another display example of the purchased commodity information screen displayed on the touch panel of the radio communication terminal in the first embodiment;

FIG. 14 is a diagram of a display example of a returned commodity information screen displayed on the touch panel of the radio communication terminal in the first embodiment;

FIG. 15 is a schematic diagram of a purchase file formed in a RAM of a radio communication terminal in a second embodiment;

FIG. 16 is a flowchart for explaining a main procedure of checkout processing executed by a CPU of a POS terminal in the second embodiment; and

FIG. 17 is a flowchart for specifically explaining a discount determination processing step executed by a CPU of the radio communication terminal in the second embodiment.

### DETAILED DESCRIPTION

In general, according to one embodiment, a shopping supporting apparatus includes a commodity specifying unit, a purchase file, a privilege granting unit, a privilege display unit, and an output unit. The commodity specifying unit specifies commodities that a customer desires to purchase. The purchase file stores, by commodity, as information concerning the purchase-desired commodities specified by the specifying unit, at least the numbers of purchase-planned items and purchase-planned amounts of the commodities. The privilege granting unit grants a privilege to the purchase of the purchase-desired commodities when a total of a total number of purchased items of the purchase-desired commodities obtained from a purchase-results storing unit, which stores information concerning commodities already purchased by the customer, and the numbers of purchase-planned items of the same commodities stored in the purchase file or a total of a total amount of purchased items of the purchase-desired commodities obtained from the purchase-results storing unit and purchase-planned amounts of the same commodities stored in the purchase file is equal to or larger than a threshold. The privilege display unit displays information concerning the privilege granted by the privilege granting unit. The output unit outputs the information concerning the purchase-desired commodities stored in the purchase file and the information concerning the privilege granted by the privilege granting unit.

### FIRST EMBODIMENT

First, a first embodiment is explained in which a privilege of a discount is granted when a total number of purchased items of a specific commodity including items purchased in the present shopping reaches a fixed value.

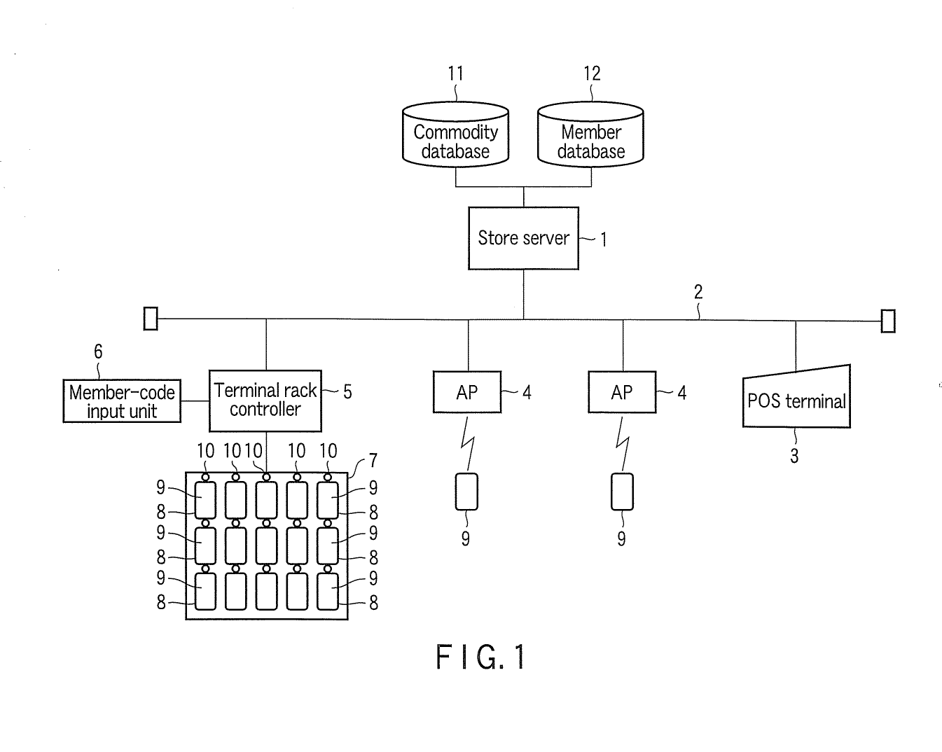

FIG. 1 is a diagram of a system according to the first embodiment. This system is built in a retail store such as a supermarket. This system includes a store server 1 as a center unit of the system. A point of sales (POS) terminal 3, access points 4, and a terminal rack controller 5 are connected to the store server 1 via a network 2 such as a local area network (LAN).

The store server 1 manages a commodity database 11 and a member database 12.

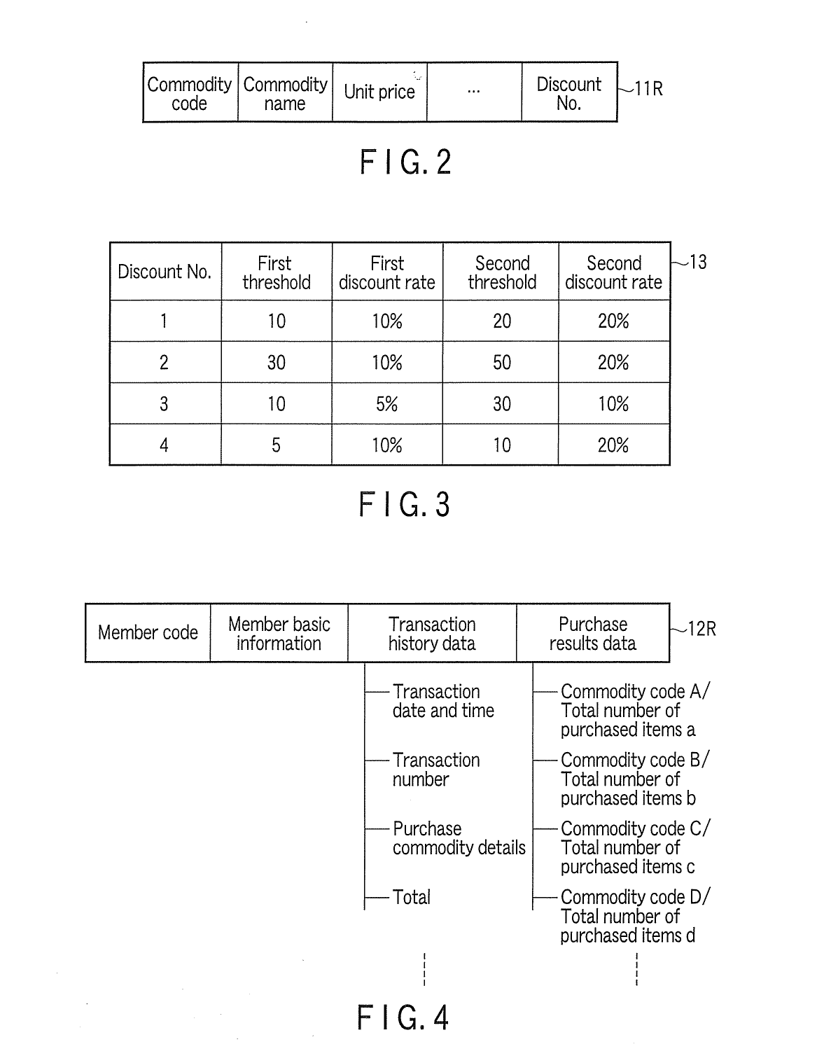

The commodity database 11 stores a commodity data record 11R for each of commodities sold in a store. As shown in FIG. 2, the commodity data record 11R includes a commodity code, a commodity name, a unit price, and a discount number.

The commodity code is a peculiar code set for each of the commodities in order to identify the commodities. The commodities are specified by commodity codes. The commodity name is a name of a commodity specified by a commodity code corresponding to the name. The unit price is a normal sales price per one item of the commodity. The discount number is an identification number set for each of plural discount pattern data registered in a discount pattern table 13 explained later. In the commodity data record 11R, when a discount is applied to a commodity specified by a commodity code in the record, a discount number of pattern data of the applied discount is set.

FIG. 3 is an example of the discount pattern table 13. The discount pattern table 13 stores four patterns of discount pattern data in which discount rates (a first discount rate and a second discount rate: the first discount rate<the second discount rate) are respectively set for thresholds in two stages (a first threshold and a second threshold: the first threshold<the second threshold).

The threshold is a comparative value for a total number of purchased items of a specific commodity. In this embodiment, when the total number of purchased items of the specific commodity reaches the threshold, the commodity is sold at a discount of a discount rate corresponding to the threshold. This means that, for example, in FIG. 3, in the case of discount pattern data for which a discount number “1” is set, a 10% discount is performed when the total number of purchased items reaches “10” and a 20% discount is performed when the total number of purchased items reaches “20”.

The number of stages of thresholds set in the discount pattern table 13 is not limited to two. The number of stages may be three or more or only one. It goes without saying that the number of patterns of the discount pattern data is not limited to four either.

The member database 12 stores a member data record 12R for each of customers registered as members. As shown in FIG. 4, the member data record 12R includes a member code, member basic information, transaction history data, and purchase results data.

The member code is a peculiar code set for a customer as a member. The customer is specified by the member code. In member cards owned by the customers, at least member codes set for the members are recorded.

The member basic information includes a name, age, sex, an address, a telephone number, and a family make-up of the customer specified by the member code. The transaction history data is data such as a history of shopping in the store of the customer specified by the commodity code, i.e., detail information such as dates and times of transactions, transaction numbers, commodity codes of purchased commodities, the numbers of sold items, and sales amounts and total amounts. The transaction history data is generated on the basis of transaction data collected from the POS terminal 3 and accumulated on the member database 12 by customer.

The purchase results data is data in which total numbers of purchased items by commodity of commodities that the customer specified by the member code purchases in the store in a period set in advance and commodity codes of the commodities are associated. The member database 12 functions as a purchase-results storing unit configured to store information concerning commodities already purchased by the customer.

The store server 1 reads out, every time a date of each business day is updated, one member data record 12R from the member database 12 at a time. The store server 1 performs processing for updating the purchase results data of the member data record 12R. Specifically, the store server 1 acquires transaction history data for one year from the previous day to the same day of the last year. The store server 1 accumulates, by commodity code, the number of sold items of the same commodity code. A period in which purchase result data is calculated is not limited to one year and can be set and changed as appropriate according to the operation of the store. The period does not always have to be specifically set.

The terminal rack controller 5 connects a member-code input unit 6 and a terminal rack 7. The member-code input unit 6 is served for input of the member codes respectively allocated to the customers as members. For example, it is equivalent to a card reader for reading a member code from a member card.

The terminal rack 7 includes plural terminal placing tables 8. Radio communication terminals 9 are respectively detachably placed on the placing tables 8. Display units 10 such as LEDs are provided to correspond to the placing tables 8 in a one to one relation.

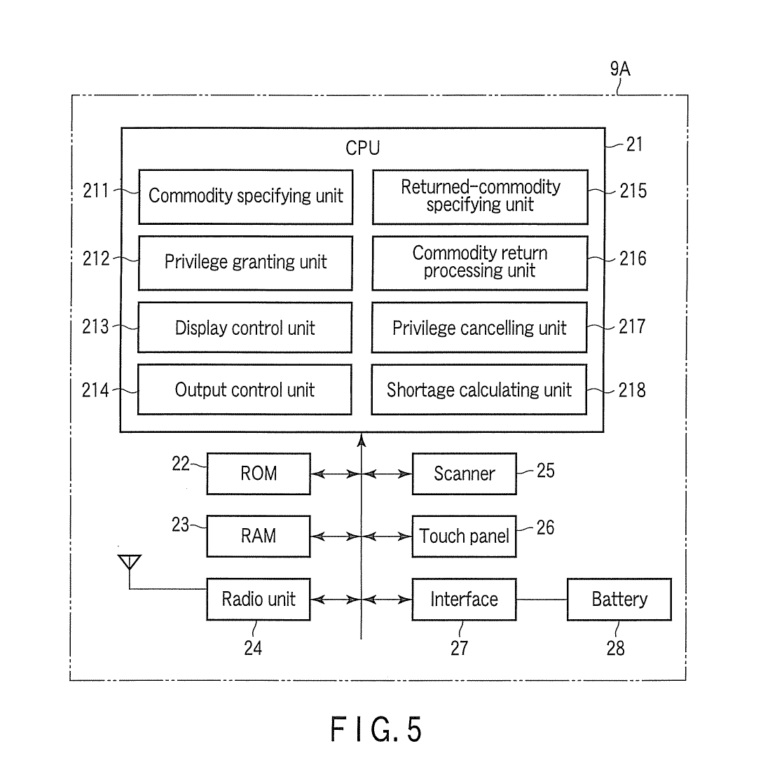

The radio communication terminal 9 is a form of the shopping supporting apparatus. A main part configuration of the radio communication terminal 9 is shown in a block diagram in FIG. 5. Specifically, the radio communication terminal 9 includes, in a portable main body 9A, a central processing unit (CPU) 21, a read only memory (ROM) 22, a random access memory (RAM) 23, a radio unit 24, a scanner 25, a touch panel 26, an interface 27, and a battery 28.

The scanner 25 is served for reading of a barcode attached to a commodity. The barcode includes a commodity code for specifying the commodity. The scanner 25 functions as an input unit for the commodity code. The input unit is not limited to the scanner 25. The input unit only has to be capable of acquiring a commodity code that can specify a commodity. For example, a radio frequency identification (RFID) reader for reading a commodity code from an RFID tag, a keyboard that can input a commodity code as numbers, or the like also functions as the input unit for a commodity code.

The touch panel 26 functions as a display device for information necessary for shopping support for a customer who uses the radio communication terminal 9 and an input device for various touch keys. A display without a touch panel may be used as a display device by providing a keyboard.

The radio unit 24 performs data communication by radio between the radio communication terminal 9 and the access points 4. The interface 27 performs transmission and reception of data through electric connection with an external apparatus and charges the battery 28 with an electric signal from the external apparatus.

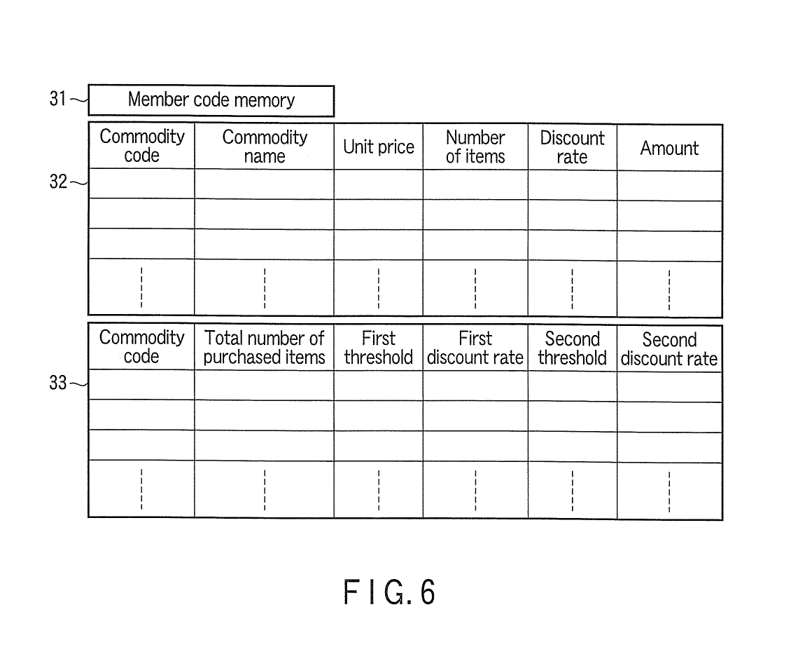

FIG. 6 is a diagram of a main memory area formed in the RAM 23 of the radio communication terminal 9. As shown in the figure, in the radio communication terminal 9, a member code memory 31, a purchase file 32, and a discount file 33 are formed in the RAM 23.

The member code memory 31 stores a member code of the customer who uses the radio communication terminal 9.

The purchase file 32 stores commodity purchase information such as a commodity code, a commodity name, a unit price, the number of items (a quantity), a discount rate, and an amount of a commodity that the customer who uses the radio communication terminal 9 determines to purchase.

The discount file 33 stores the commodity code, a total number of purchased items, and discount pattern data (a first threshold, a first discount rate, a second threshold, and a second discount rate) of the commodity that the customer who uses the radio communication terminal 9 determines to purchase.

The CPU 21 of the radio communication terminal 9 has functions of a commodity specifying unit 211, a privilege granting unit 212, a display control unit 213, an output control unit 214, a returned-commodity specifying unit 215, a commodity return processing unit 216, a privilege cancelling unit 217, and a shortage calculating unit 218. Details of the functions are explained later.

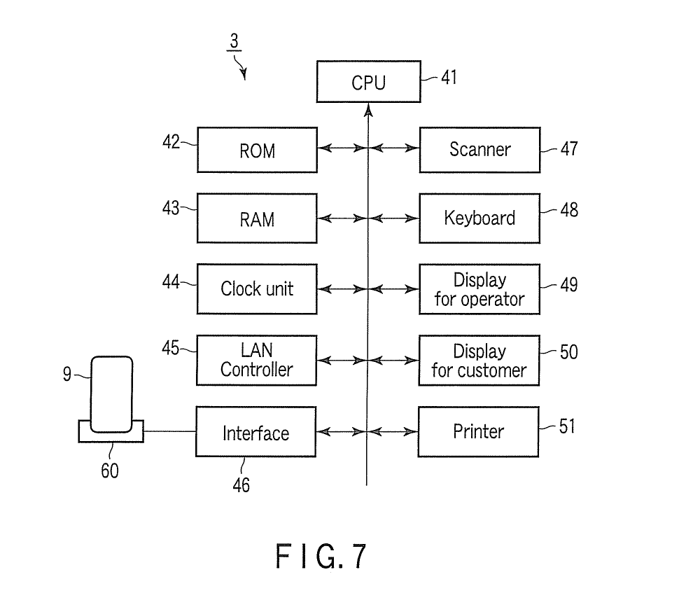

The POS terminal 3 is a form of the commodity sales data processing apparatus. A main part configuration of the POS terminal 3 is shown in a block diagram of FIG. 7. Specifically, the POS terminal 3 includes a CPU 41, a ROM 42, a RAM 43, a clock unit 44, a LAN controller 45, an interface 46, a scanner 47, a keyboard 48, a display device for operator 49, a display device for customer 50, and a printer 51.

A cradle 60 is connected to the interface 46. The cradle 60 functions as a docking station for the radio communication terminal 9. When the radio communication terminal 9 is placed on the cradle 60, the interface 27 of the radio communication terminal 9 and the interface 46 of the POS terminal 3 are electrically connected via the cradle 60. This makes it possible to exchange data signals between the radio communication terminal 9 and the POS terminal 3.

In a retail store where this system is built, the terminal rack 7 is set at the entrance of the store, for example. The radio communication terminals 9 are respectively placed on the terminal placing tables 8 of the terminal rack 7. When the radio communication terminal 9 is placed on the terminal placing table 8, the radio communication terminal 9 is electrically connected to the terminal rack controller 5 via the interface 27 and the battery 28 is charged.

The member-code input unit 6 is provided near the terminal rack 7. A customer who visits the store inputs a member code of the customer via the member-code input unit 6. When the member code is input, the terminal rack controller 5 transmits the member code to the store server 1 and inquires the store server 1 about member data. The inquired store server 1 searches through the member database 12 and confirms whether the member data record 12R including the member code is registered. If the store server 1 confirms that the member data record 12R is registered, the store server 1 returns an approval response to the terminal rack controller 5.

When the terminal rack controller 5 receives the approval response from the store server 1, the terminal rack controller 5 selects one radio communication terminal 9 placed on any one of the terminal placing tables 8. The terminal rack controller 5 writes the member code, which is input via the member-code input unit 6, in the member code memory 31. For example, the terminal rack controller 5 causes the display unit 10 corresponding to the terminal placing table 8, on which the radio communication terminal 9 is placed, to blink. The purchase file 32 and the discount file 33 of the radio communication terminal 9 are cleared in an initial state.

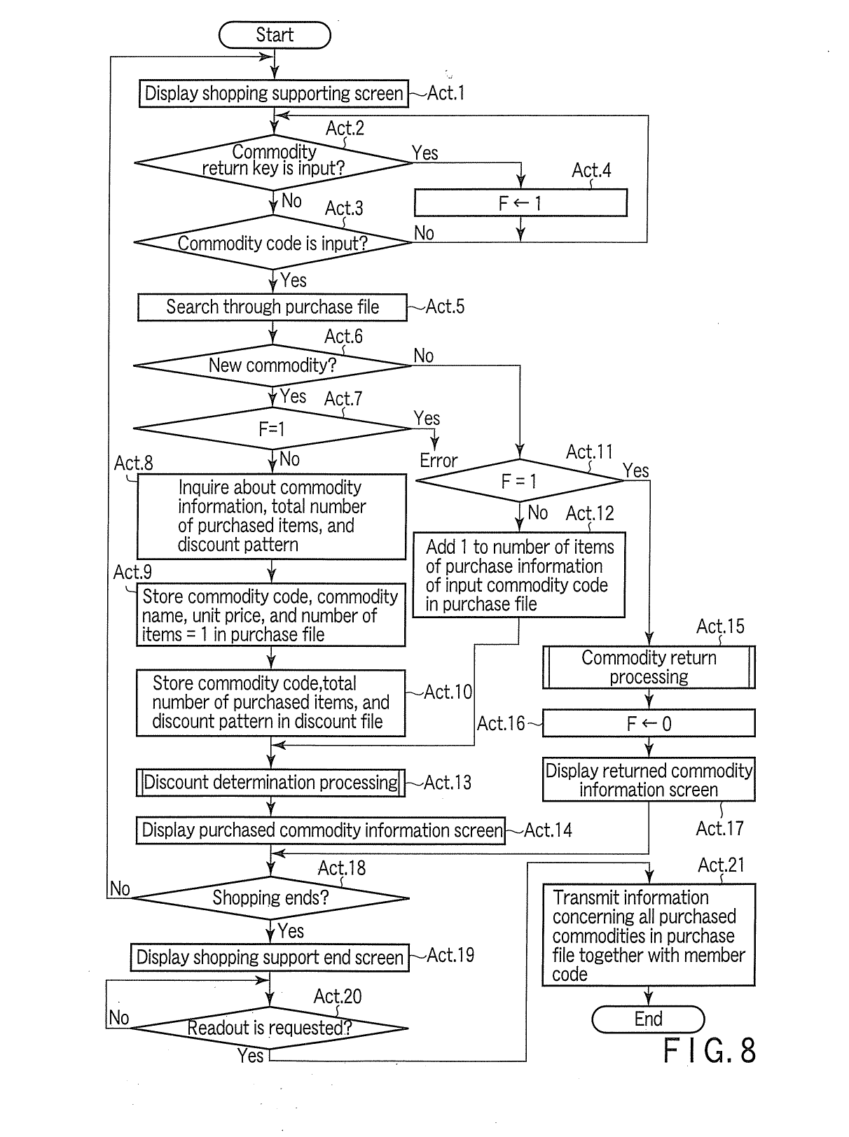

The customer who confirms the blinking of the display unit 10 removes the radio communication terminal 9 from the terminal placing table 8 corresponding to the display unit 10. A driving power supply for the radio communication terminal 9 removed from the terminal placing table 8 is switched to the battery 28. Thereafter, the CPU 21 of the radio communication terminal 9 operates according to a procedure shown in a flowchart of FIG. 8. This operation is realized by a shopping supporting program in the ROM 22.

When the shopping supporting program is started, the CPU 21 causes the touch panel 26 to display a shopping supporting screen 70 (Act 1).

A display example of the shopping supporting screen 70 is shown in FIG. 11. As shown in the figure, the shopping supporting screen 70 displays guidance 71 for commodity purchase and guidance 72 for commodity return. When the customer carrying the radio communication terminal 9 puts a commodity, which the customer is about to purchase in the selling floor, in the shopping cart, the guidance 71 instructs the customer to read a barcode attached to the commodity with the scanner 25. When the customer returns a commodity, which the customer once puts in the shopping cart, to a commodity shelf before checkout, the guidance 72 instructs the customer to touch a commodity return key 73 on the touch panel 26 and, after reading a barcode of the commodity to be returned with the scanner 25, return the commodity to the commodity shelf.

The CPU 21, which causes the touch panel 26 to display the shopping supporting screen 70, stands by for the commodity return key 73 to be touch-operated (Act 2) or a commodity code to be input (Act 3). If the CPU 21 detects according to a signal from the touch panel 26 that the commodity return key 73 is touch-operated (YES in Act 2), the CPU 21 sets a commodity return flag F to “1” (Act 4). The CPU 21 stands by for the commodity return key 73 to be touch-operated again (Act 2) or a commodity code to be input (Act 3). The commodity return flag F is stored in the RAM 23.

When the CPU 21 detects according to a signal from the scanner 25 that the barcode is scanned, the CPU 21 inputs a commodity code from barcode data of the barcode (Yes in Act 3). In order to determine whether a commodity specified by the commodity code is a new commodity, the CPU 21 searches through the purchase file 32 (Act 5).

As a result of searching through the purchase file 32, if commodity purchase information including a commodity code same as the input commodity code is not detected, the commodity specified by the commodity code is a new commodity. On the other hand, if commodity purchase information including the same commodity code is detected, the commodity specified by the commodity code is not a new commodity (Act 6).

If the commodity specified by the commodity code is a new commodity (YES in Act 6), the CPU 21 checks the commodity return flag F (Act 7). If the commodity return flag F is set to “1” (YES in Act 7), input operation for the commodity code is wrong operation for inputting a commodity code unregistered as a purchased commodity as a commodity code of a returned commodity. In this case, the CPU 21 determines the input of the commodity code as an error. The CPU 21 returns to the processing in Act 1 after resetting the commodity return flag F to “0”.

If the commodity return flag F is reset to “0” in processing in Act 7 (NO in Act 7), the input operation for the commodity code is valid operation for inputting a commodity code of a purchased commodity. In this case, the CPU 21 specifies a commodity identified by the input commodity code as a purchased commodity (the commodity specifying unit 211). The CPU 21 creates an inquiry transmission message for the purchased commodity and transmits the inquiry transmission message to the store server 1 by radio via the radio unit 24 (Act 8). The inquiry transmission message includes the input commodity code and the member code stored in the member code memory 31.

The inquiry transmission message is transmitted to the store server 1 through any one of the access points 4. The store server 1 searches through the commodity database 11 with the commodity code in the received transmission message. The store server 1 reads out commodity information such as a commodity name and a unit price from a commodity data record in which the same commodity code is set.

The store server 1 searches through the discount pattern table 13 with a discount number in the commodity data record. The store server 1 reads out discount pattern data (a first threshold, a first discount rate, a second threshold, and a second discount rate) stored to correspond to the same discount number.

The store server 1 searches through the member database 12 with the commodity code in the received transmission message. The store server 1 reads out a total number of purchased items of a commodity specified by the commodity code in the received transmission message from purchase results data in the member data record in which the same member code is set.

In this way, the store server 1 transmits the commodity information such as the commodity code, the commodity name, and the unit price, the discount pattern data, and the total number of purchased items of the commodity specified by the commodity code to the radio communication terminal 9 at an inquiry source by radio.

The data transmitted from the store server 1 is transmitted to the radio communication terminal 9 at the inquiry source through any one of the access points 4.

The CPU 21 that receives the transmitted data via the radio unit 24 describes the commodity code, the commodity name, the unit price, the number of items, a discount rate, and an amount in the purchase file 32 as commodity purchase information. The number of items is “1”. The discount rate is “0”. The amount is a value calculated as “(unit price×number of items)−(unit price×number of items×discount rate)” (Act 9).

The CPU 21 describes the received commodity code, total number of purchased items, and discount pattern data in the discount file 33 (Act 10). Thereafter, the CPU 21 executes discount determination processing explained later (Act 13).

If it is determined in the processing in Act 6 that the commodity is not a new commodity (NO in Act 6), the CPU 21 checks the commodity return flag F (Act 11). If the commodity return flag F is reset to “0” (NO in Act 11), the input operation for the commodity code is valid operation for instructing purchase of second and subsequent items of the commodity already registered as the purchased commodity. In this case, the CPU 21 adds “1” to the number of items of commodity purchase information in which the input commodity code in the purchase file 32 is set (Act 12). The CPU 21 updates an amount of the commodity purchase information to an amount after the addition of the number of items. Thereafter, the CPU 21 executes discount determination processing explained later (Act 13).

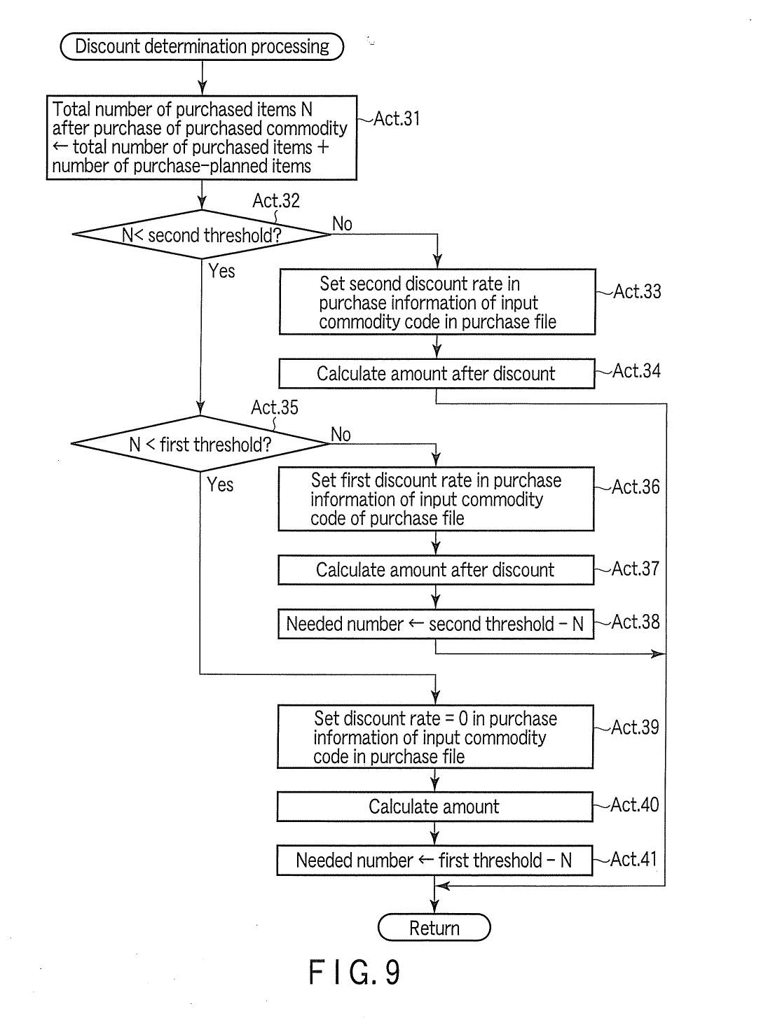

A specific processing procedure of the discount determination processing is indicated by a flowchart of FIG. 9.

When the discount determination processing is started, first, the CPU 21 calculates a total number of purchased items N after the purchase of the purchased commodity. In other words, the CPU 21 adds the number of items (the number of purchase-planned items) of the purchased commodity stored in the purchase file 32 to a total number of purchased items of the purchased commodity stored in the discount file 33 (Act 31).

Subsequently, the CPU 21 invokes the second threshold and the second discount rate from discount pattern data of the purchased commodity stored in the discount file 33. The CPU 21 compares the total number of purchased items N after the purchase and the second threshold (Act 32).

As a result, if the total number of purchased items N after the purchase is equal to or larger than the second threshold (NO in Act 32), the CPU 21 sets the second discount rate in purchase information of the purchased commodity in the purchase file 32 (Act 33). The CPU 21 updates an amount of the purchase information of the purchased commodity to an amount discounted at the second discount rate (Act 34: the privilege granting unit 212).

On the other hand, if the total number of purchased items N after the purchase is smaller than the second threshold (YES in Act 32), the CPU 21 invokes the first threshold and the first discount rate from discount pattern data of the purchased commodity stored in the discount file 33. The CPU 21 compares the total number of purchased items N after the purchase and the first threshold (Act 35).

As a result, if the total number of purchased items N after the purchase is equal to or larger than the first threshold (NO in Act 35), the CPU 21 sets the first discount rate in purchase information of the purchased commodity in the purchase file 32 (Act 36). The CPU 21 updates an amount of the purchase information of the purchased commodity to an amount discounted at the first discount rate (Act 37: the privilege granting unit 212). Further, the CPU 21 calculates a value obtained by subtracting the total number of purchased items N after the purchase from the second threshold as the number of items needed to grant a privilege by the second discount rate (Act 38: the shortage calculating unit 218).

If the total number of purchased items N after the purchase is smaller than the first threshold (YES in Act 35), the CPU 21 sets the discount rate of the purchase information of the purchased commodity in the purchase file 32 to “0” (Act 39). The CPU 21 updates the amount of the purchase information of the purchased commodity to an amount without a discount (Act 40). Further, the CPU 21 calculates a value obtained by subtracting the total number of purchased items N after the purchase from the first threshold as the number of items needed to grant a privilege by the first discount rate (Act 41: the shortage calculating unit 218).

The explanation is returned to FIG. 8.

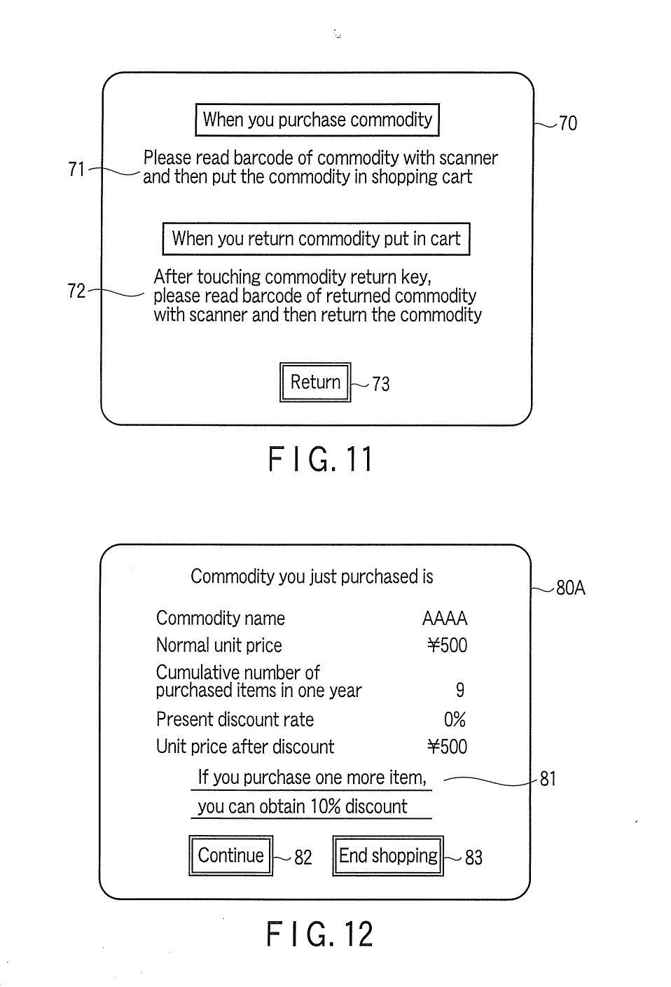

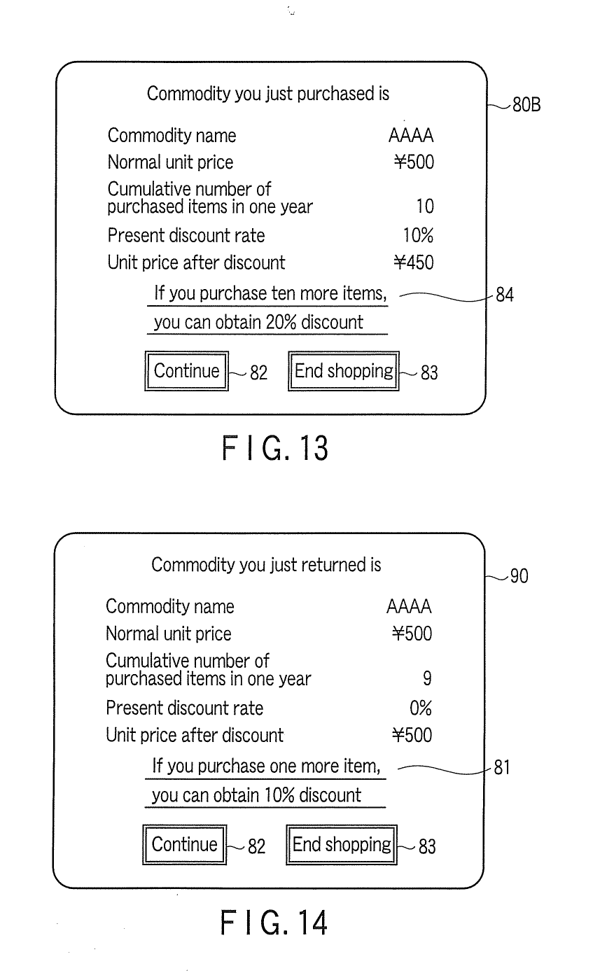

If the discount determination processing explained above is executed, the CPU 21 causes the touch panel 26 to display a purchased commodity information screen 80 (Act 14: the display control unit 213). A display example of the purchased commodity information screen 80 is shown in FIGS. 12 and 13.

A purchased commodity information screen 80A shown in FIG. 12 is a screen displayed when a customer, who purchased eight items of a commodity AAAA at a unit price of 500 yen in the last one year, scans a barcode with the scanner 25 in order to purchase one item in the present shopping. It is assumed that a discount pattern for the commodity AAAA is a pattern with the discount number “1” in FIG. 3. In the discount pattern with the discount number “1”, the first threshold is “10”, the second threshold is “20”, the first discount rate is “10%”, and the second discount rate is “20%”.

In this case, the total number of purchased items N after the purchase of the commodity AAAA is “9”, which is smaller than the first threshold. Therefore, the respective kinds of processing in Acts 39, 40, and 41 of the discount determination processing routine are executed. As a result, as shown in FIG. 12, a commodity name AAAA, a normal unit price \500, a total number of purchased items after purchase (a cumulative number of purchased items in one year) “9”, the present discount rate “0%”, the unit price after discount \500, and a privilege notice message 81 are displayed on the purchased commodity information screen 80A. A “continue” key 82 that a customer touches when continuing shopping and a “end shopping” key 83 that the customer touches when ending the shopping are also displayed on the purchased commodity information screen 80A.

The privilege notice message 81 notifies the customer that a discount at the first discount rate “10%” is obtained if the customer purchases “one” more item of the commodity AAAA.

A purchased commodity information screen 80B shown in FIG. 13 is a screen displayed when a customer, who confirms the screen 80A shown in FIG. 12, scans a barcode with the scanner 25 in order to purchase one more item of the commodity AAAA. In this case, the total number of purchased items N after the purchase is “10”, which reaches the first threshold. Therefore, a discount condition of the first discount rate “10%” corresponding to the first threshold is satisfied.

As a result, as shown in FIG. 13, besides the commodity name AAAA, the normal unit price \500, and the total number of purchased items after the purchase (the cumulative number of purchased items in one year) “10”, the present discount rate “10%” and a unit price after discount \450 are displayed on the purchased commodity information screen 80B as information for notifying the customer that a privilege by a discount is granted. In addition, a privilege notice message 84 is also displayed on the purchased commodity information screen 80B. The privilege notice message 84 notifies the customer that a discount of the second discount rate “20%” is obtained if the customer purchases “ten” more items of the commodity AAAA.

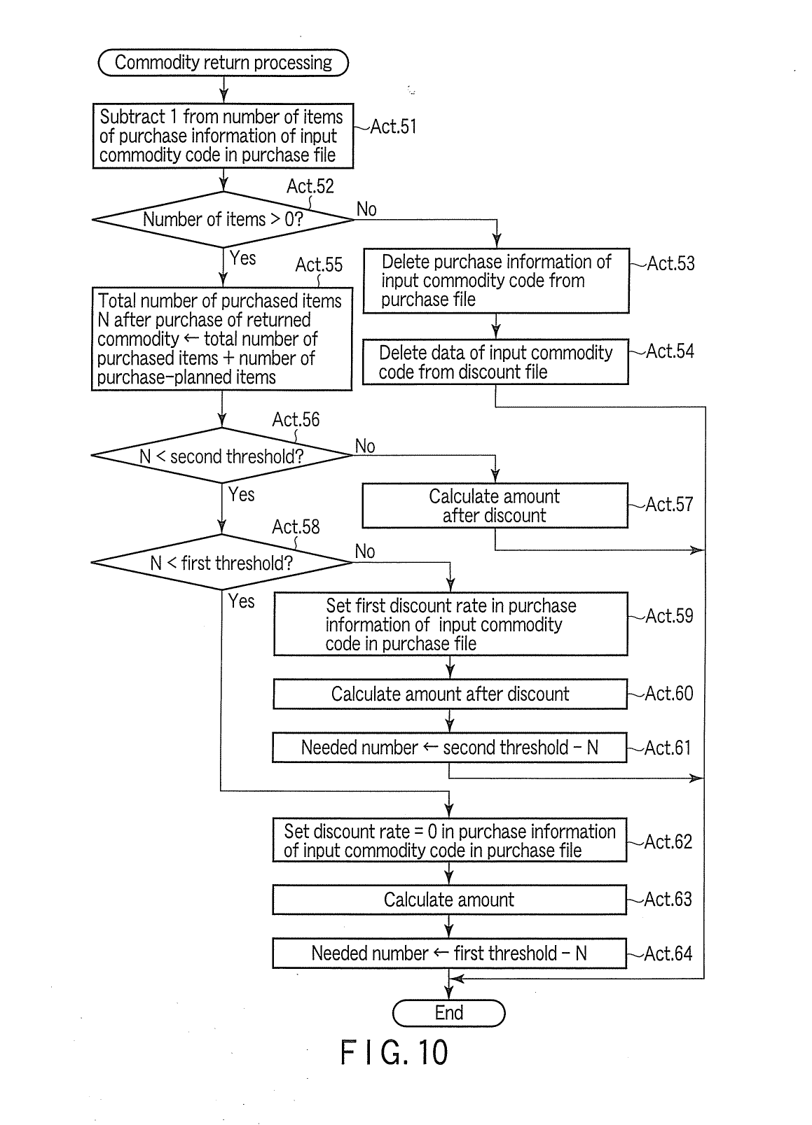

If the commodity return flag F is set to “1” in the processing in Act 11 (YES in Act 11), the input operation of the commodity code is valid operation for instructing return of a commodity registered as a purchased commodity. In this case, the CPU 21 specifies a commodity identified by the input commodity code as a returned commodity (the returned-commodity specifying unit 215). The CPU 21 executes commodity return processing specifically shown in FIG. 10 (Act 15).

Specifically, the CPU 21 subtracts “1” from the number of items of the purchase information including the input commodity code in the purchase file 32 (Act 51: the commodity return processing unit 216). The CPU 21 determines whether the number of items after the subtraction is equal to or larger than “1” or is “0” (Act 52).

If the number of items after the subtraction is “0” (NO in Act 52), the CPU 21 deletes the purchase information including the input commodity code from the purchase file 32 (Act 53). The CPU 21 deletes the commodity code, the total number of purchased items, and the discount pattern data of the record including the input commodity code from the discount file 33 (Act 54).

On the other hand, if the number of items after the subtraction is equal to or larger than “1” (YES in Act 52), the CPU 21 executes processing same as the respective kinds of processing in Acts 31, 32, 34, 35, 36, 37, 38, 39, 40, and 41 of the discount determination processing.

Specifically, in order to calculate the total number of purchased items N after the purchase of the returned commodity, the CPU 21 adds the number of items (the number of purchased-planned items) of the purchased commodity stored in the purchase file 32 to the total number of purchased items of the purchased commodity stored in the discount file 33 (Act 55).

Subsequently, the CPU 21 invokes the second threshold and the second discount rate from the discount pattern data of the purchased commodity stored in the discount file 33. The CPU 21 compares the total number of purchased items N after the purchase and the second threshold (Act 56).

As a result, if the total number of purchased items N after the purchase is equal to or larger than the second threshold (NO in Act 56), the CPU 21 updates an amount of purchase information of the returned commodity in the purchase file 32 to an amount discounted at the second discount rate (Act 57: the privilege granting unit 212).

On the other hand, if the total number of purchased items N after the purchase is smaller than the second threshold (YES in Act 56), the CPU 21 invokes the first threshold and the first discount rate from discount pattern data of the returned commodity stored in the discount file 33. The CPU 21 compares the total number of purchased items N after the purchase and the first threshold (Act 58).

As a result, if the total number of purchased items N after the purchase is equal to or larger than the first threshold (NO in Act 58), the CPU 21 sets the first discount rate in the purchase information of the returned commodity of the purchase file 32 (Act 59). The CPU 21 updates the amount of the purchase information of the returned commodity to an amount discounted at the first discount rate (Act 60: the privilege granting unit 212). The CPU 21 calculates a value obtained by subtracting the total number of purchased items N after the purchase from the second threshold as the number of items needed to grant a privilege by the second discount rate (Act 61: the shortage calculating unit 218).

If the total number of purchased items N after the purchase is smaller than the first threshold (YES in Act 58), the CPU 21 sets a discount rate of the purchase information of the returned commodity of the purchase, file 32 to “0” (Act 62). The CPU 21 updates the amount of the purchase information of the returned commodity to an amount without a discount (Act 63). The CPU 21 calculates a value obtained by subtracting the total number of purchased items N after the purchase from the first threshold as the number of items needed to grant a privilege by the first discount rate (Act 64: the shortage calculating unit 218).

The explanation is returned to FIG. 8 again.

If the commodity return processing explained above is executed, the CPU 21 resets the commodity return flag F to “0” (Act 16). The CPU 21 causes the touch panel 26 to display a returned commodity information screen 90 (Act 17: the display control unit 213). A display example of the returned commodity information screen 90 is shown in FIG. 14.

The returned commodity information screen 90 shown in FIG. 14 is a screen displayed when the customer, who confirms the screen 80B shown in FIG. 13, returns the commodity AAAA while continuing shopping thereafter. In this case, after touching the commodity return key 73 of the shopping supporting screen 70, the customer scans a barcode of the commodity AAAA with the scanner 25. Then, since the total number of purchased items N after the purchase is “9”, the present discount rate is “0%” and a unit price after discount is \500 same as the normal unit price. The privilege notice message 81 is displayed again. Besides, the “continue” key 82 and the “end shopping” key 83 are also displayed on the returned commodity information screen 90.

After displaying the purchased commodity information screen 80 or the returned commodity information screen 90, the CPU 21 stands by for the “continue” key 82 or the “end shopping” key 83 to be touch-operated (Act 18). If the touch-operation of the “continue” key 82 is detected according to a signal from the touch panel 26 (NO in Act 18), the CPU 21 returns to the processing in Act 1. In other words, the CPU 21 returns the screen of the touch panel 26 to the shopping supporting screen 70 and stands by for a barcode of the next purchased commodity or returned commodity to be scanned.

If the touch-operation of the “end shopping” key 83 is detected according to a signal from the touch panel 26 (YES in Act 18), the CPU 21 switches the screen of the touch panel 26 to a shopping support end screen (Act 19). The CPU 21 stands by for a readout request command (Act 20).

If the readout request command is received via the interface 27 in this state (YES in Act 20), the CPU 21 transmits a member code in the member code memory 31 and data of the purchase file 32 to a request command transmission source via the interface 27 (Act 21: the output control unit 214). The present processing conforming to the shopping supporting program ends.

The customer who ends the shopping in the selling floor touches the “end shopping” key 83 of the touch panel 26. The customer goes to a checkout place to pay the price for the purchased commodity and places the radio communication terminal 9 on the cradle 60. When the casher confirms that the radio communication terminal 9 is placed on the cradle 60, the casher depresses a member checkout key of the keyboard 48.

When the member checkout key is depressed, the CPU 41 of the POS terminal 3 executes checkout processing.

First, the CPU 41 transmits a readout request command via the interface 46. The readout request command is given to the radio communication terminal 9 placed on the cradle 60.

Consequently, the radio communication terminal 9 transmits the member code in the member code memory 31 and the data of the purchase file 32. The CPU 41 receives the data from the radio communication terminal 9 and temporarily stores the data in a work area of the RAM 43.

Subsequently, the CPU 41 performs registration processing for commodity sales data on the basis of the data of the purchase file 32 received from the radio communication terminal 9. According to the registration processing, the CPU 41 creates transaction data including detail data of the purchased commodity. The CPU 41 causes, on the basis of a result of the registration processing, the display for operator 49 and the display for customer 50 to display checkout data such as a charged amount.

In the POS terminal 3, the registration processing for the commodity sales data is performed on the basis of the data of the purchase file 32. Therefore, when a discount rate is set in the data of the purchase file 32, the commodity is discounted at the discount rate and sold.

Thereafter, the CPU 41 stands by for the closing key of the keyboard 48 to be input. When the closing key is input, the CPU 41 executes the checkout processing. In the checkout processing, for example, the CPU 41 receives input of a deposit amount. When the deposit amount is input, the CPU 41 subtracts the charged amount from the deposit amount to calculate a change amount and displays the change amount.

When the CPU 41 ends the checkout processing, the CPU 41 issues a receipt on which details of a commercial transaction, a granted point, and the like are printed. The CPU 41 transmits the member code received from the radio communication terminal 9 and the transaction data generated this time from the LAN controller 45 to the store server 1 through the network 2.

The store server 1 that receives the data from the POS terminal 3 adds the present transaction data to transaction history data of the record 12R of the member database 12 specified by the member code in the received data.

In this way, when the customer carrying the radio communication terminal 9 reads a barcode of a commodity, which the customer is about to purchase in the selling floor, with the scanner 25 of the terminal 9, information concerning the commodity is displayed on the touch panel 26 of the terminal 9. When the total number of purchased items N after the purchase of the commodity exceeds the first threshold or the second threshold and the discount condition is satisfied, a discount rate and a unit price after discount are immediately displayed on the touch panel 26 to notify the customer that a privilege of a discount is granted. Therefore, the customer can learn that the customer can be granted with the privilege before checkout. As a result, since eagerness to buy of the customer is increased, an effect of sales promotion can be expected.

Information about the number of items necessary for satisfying a discount condition with a higher discount rate is also displayed on the touch panel 26. Therefore, the eagerness to buy of the customer is further increased and a further effect of sales promotion can be expected.

### SECOND EMBODIMENT

A second embodiment is explained in which, when the total number of purchased items of a specific commodity exceeds a fixed value in shopping up to the last time, a privilege of a discount is granted and, when the total number of purchased items of the specific commodity in shopping including the present shopping reaches the fixed value, a privilege of issuance of a service ticket is granted.

In the following explanation, only differences from the first embodiment are explained. Components same as those in the first embodiment are denoted by the same reference numerals and signs and explanation of the components is omitted.

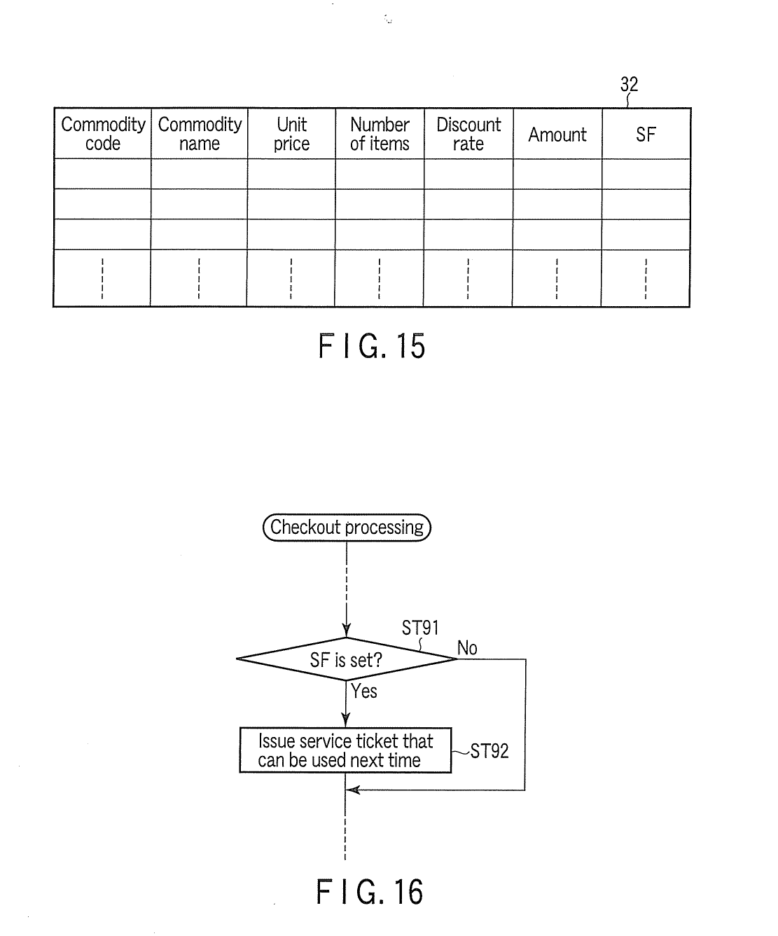

One of the differences of the second embodiment from the first embodiment is data structure of the purchase file 32. As shown in FIG. 15, the purchase file 32 stores a service flag SF in addition to commodity purchase information such as a commodity code, a commodity name, a unit price, the number of items, a discount rate, and an amount of a commodity that a customer who uses the radio communication terminal 9 determines to purchase.

The service flag SF is set when the total number of purchased items including the number of purchased items in the present shopping of a commodity specified by a commodity code corresponding to the commodity reaches the first threshold. Data of the purchase file 32 is transmitted and output from the radio communication terminal 9 to the POS terminal 3 according to a readout request command from the POS terminal 3.

As shown in FIG. 16, in the checkout processing, the CPU 41 of the POS terminal 3 determines whether there is data for which the service flag SF is set among the data of the purchase file 32 received from the radio communication terminal 9 (Act 91). When data for which the service flag SF is set is detected (YES in Act 91), the CPU 41 adds processing for printing and issuing a service ticket with the printer 51. The service ticket in this case is a ticket with which a privilege for discounting 5% on all items is obtained when presented in the next shopping.

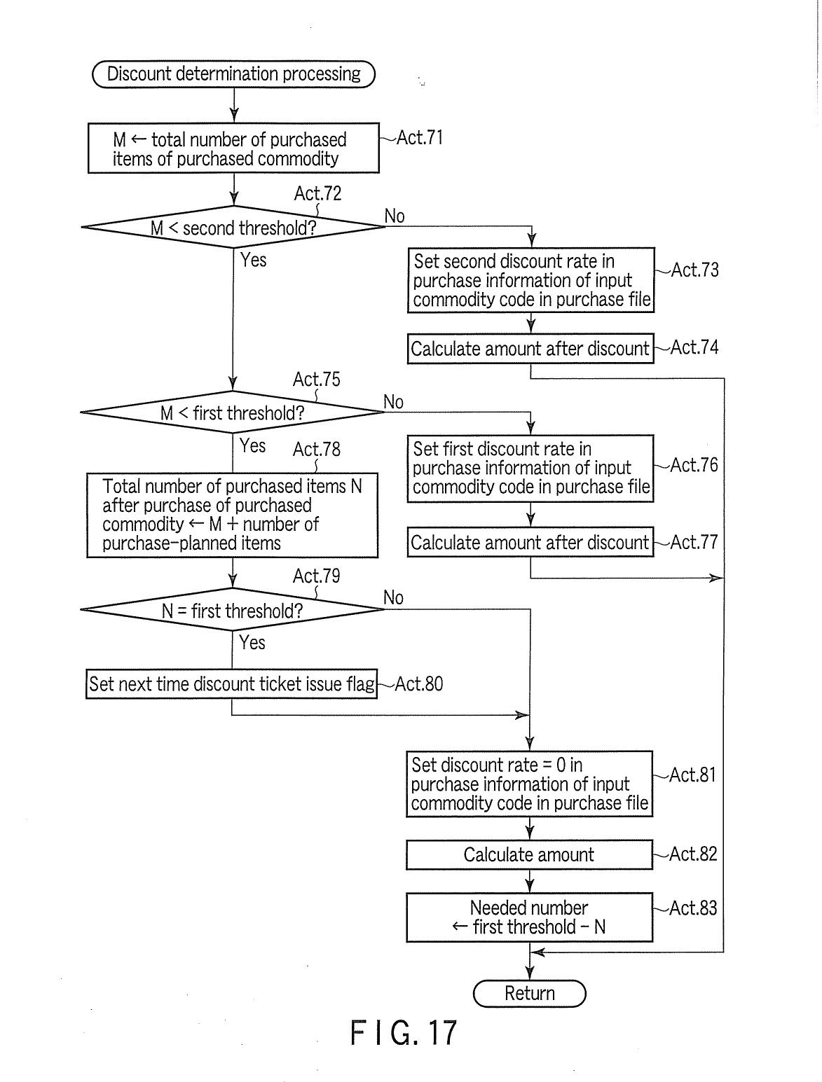

Another difference of the second embodiment from the first embodiment is a procedure of the discount determination processing executed by the CPU 21 of the radio communication terminal 9. A specific processing procedure of the discount determination processing in the second embodiment is indicated by a flowchart of FIG. 17.

When the discount determination processing is started, the CPU 21 sets the total number of purchased items of the purchased commodity stored in the discount file 33 as a comparative value M (Act 71).

Subsequently, the CPU 21 invokes the second threshold and the second discount rate from the discount pattern data of the purchased commodity stored in the discount file 33. The CPU 21 compares the comparative value M and the second threshold (Act 72). As a result, if the comparative value M is equal to or larger than the second threshold (NO in Act 72), the CPU 21 sets the second discount rate in the purchase information of the purchased commodity in the purchase file 32 (Act 73). The CPU 21 updates the amount of the purchase information of the purchased commodity to an amount discounted at the second discount rate (Act 74: the privilege granting unit 212).

If the comparative value M is smaller the second threshold (YES in Act 72), the CPU 21 invokes the first threshold and the first discount rate from the discount pattern data of the purchased commodity stored in the discount file 33. The CPU 21 compares the comparative value M and the first threshold (Act 75). As a result, if the comparative value M is equal to or larger than the first threshold (NO in Act 75), the CPU 21 sets the first discount rate in the purchase information of the purchased commodity in the purchase file 32 (Act 76). The CPU 21 updates the amount of the purchase information of the purchased commodity to an amount discounted at the first discount rate (Act 77: the privilege granting unit 212).

If the comparative value M is smaller than the first threshold, i.e., if a condition for a privilege of a discount is not satisfied (YES in Act 75), in order to calculate the total number of purchased items N after the purchase of the purchased commodity, the CPU 21 adds the number of purchase-planned items of the purchased commodity stored in the purchase file 32 to the total number of purchased items of the purchased commodity stored in the discount file 33 (Act 78). The CPU 21 determines whether the total number of purchased items N after the purchase coincides with the first threshold (Act 79).

If the total number of purchased items N after the purchase coincides with the first threshold, the CPU 21 sets the service flag SF in the purchase information of the purchased commodity (Act 80: the privilege granting unit 212). If the total number of purchased items N after the purchase is smaller than the first threshold, the CPU 21 does not execute the processing in Act 80.

Thereafter, the CPU 21 sets the discount rate of the purchase information of the purchased commodity in the purchase file 32 to “0” (Act 81). The CPU 21 updates the amount of the purchase information of the purchased commodity to an amount without a discount (Act 82). Further, the CPU 21 calculates a value obtained by subtracting the total number of purchased items N after the purchase from the first threshold as the number of items needed to grant the privilege by the first discount rate (Act 83: the shortage calculating unit 218).

In the second embodiment, a privilege is not granted until a total number of purchased items in a designated period of a specific commodity reaches the first threshold. However, since the number of items needed to reach the first threshold is displayed on the purchased commodity information screen 80A, a frequency of visit to the store by the customer can be increased.

If a total number of purchased items in the designated period of the specific commodity including the number of items purchased in the present shopping reaches the first threshold, a service ticket is issued in checkout. The service ticket is a ticket with which a privilege for discounting 5% on all items is obtained when presented in the next shopping. If such a service ticket is issued with an expiration date, it can be expected that the customer visits the store again soon.

Thereafter, every time the customer purchases the specific commodity, the total number of purchased items of which in the designated period reaches the first threshold, the customer can purchase the commodity at a discount price. Therefore, it is possible to keep the customer satisfied for a long period.

The present invention is not limited to the embodiments per se. At an implementation stage, the components can be modified and embodied without departing from the spirit of the present invention.

For example, in the first embodiment, the discount as the privilege is explained as an example. In the second embodiment, the issuance of the service ticket is explained as an example. However, types of privileges are not limited to these privileges. For example, the privileges may be a discount by a price change, presentation of a giveaway, and the like.

In the second embodiment, the processing for calculating number of items needed to grant the privilege in Act 83 is executed after the processing in Act 82. Therefore, the shortage calculating unit 218 calculates the number of items needed to grant a privilege when the condition for granting the privilege by the privilege granting unit 212 is not satisfied. However, the present invention is not limited to this.

If the total number of purchased items N after the purchase is smaller than the threshold in the processing in Act 79, the CPU 21 executes the processing for calculating the number of items needed to grant the privilege and, thereafter, proceeds to the processing in Act 81. Consequently, except when conditions for other privileges such as issuance of a discount ticket are satisfied, the shortage calculating unit 218 calculates the number of items needed to grant the privilege when the condition for granting the privilege is not satisfied.

In the first and second embodiments, the sales system for granting a privilege when a total number of purchased items of a specific commodity reaches a fixed value is explained. However, the sales system is not limited to this. When a sales system for granting a privilege when a total amount of purchased items reaches a fixed value is adopted, a threshold only has to be set to a value corresponding to the total amount of purchased items. Alternatively, by setting two kinds of thresholds for the number of items and for an amount, it is possible to realize a sales system for granting a privilege if one of a total number of purchased items and a total amount of purchased items reaches the threshold.

In the first and second embodiments, the store server 1 acquires, from the discount pattern table 13, the discount pattern data corresponding to the discount number in the commodity data record 11R read out from the commodity database 11 and transmits the discount pattern data to the radio communication terminal 9 at the inquiry source. However, a procedure for acquiring discount pattern data is not limited to this.

The store server 1 downloads the discount pattern table 13 in transmitting an approval response to the radio communication terminal 9. The CPU 21 of the radio communication terminal 9 acquires, from the discount pattern table 13, discount pattern data corresponding to a discount number in the commodity data record 11R returned from the store server 1.

In the first and second embodiments, the output unit transmits and outputs the commodity information and the privilege information stored in the purchase file 32 to the POS terminal 3. However, the configuration of the output unit is not limited to this. For example, the output unit may transmit the commodity information and the privilege information to the store server 1 by radio via the radio unit 24.

In this case, the store server 1 stores data received from the radio communication terminal 9 in association with a member code set in the terminal 9. Usually, the POS terminal 3 includes a member-code input unit such as a card reader. When a member code is input, the POS terminal 3 inquires the store server 1 about member data using the member code. The POS terminal 3 executes closing processing or the like according to data of the purchase file 32 returned from the store server 1. By adopting such a configuration, it is possible to omit the cradle 60 from the POS terminal 3.

The output unit is not limited to the transmission and output. For example, when the radio communication terminal 9 includes a printer, the output unit converts the data, of the purchase file 32 into, for example, a two-dimensional data code and print-outputs the two-dimensional data code to recording paper. In this case, the POS terminal 3 can acquire the data of the purchase file 32 by reading the two-dimensional data code with the scanner 47 and analyzing the two-dimensional data code.

In the embodiments, the shape of the main body 9A of the radio communication terminal 9 is formed to make the radio communication terminal 9 portable. A customer holds the radio communication terminal 9 and scans a commodity code. However, the main body 9A of the radio communication terminal 9 may be attached to a shopping cart and carried to enable the customer to scan the commodity code without holding the radio communication terminal 9.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A portable shopping supporting apparatus comprising:
a commodity specifying unit configured to specify commodities that a customer desires to purchase;
a purchase file configured to store, by commodity, as information concerning the purchase-desired commodities specified by the specifying unit, at least numbers of purchase-planned items and purchase-planned amounts of the commodities;
a privilege granting unit configured to grant a privilege to the purchase of the purchase-desired commodities when a total of a total number of purchased items of the purchase-desired commodities obtained from a purchase-results storing unit, which stores information concerning commodities already purchased by the customer, and numbers of purchase-planned items of same commodities stored in the purchase file or a total of a total amount of purchased items of the purchase-desired commodities obtained from the purchase-results storing unit and purchase-planned amounts of the same commodities stored in the purchase file is equal to or larger than a threshold;
a privilege display unit configured to display information concerning the privilege granted by the privilege granting unit; and
an output unit configured to output the information concerning the purchase-desired commodities stored in the purchase file and the information concerning the privilege granted by the privilege granting unit.

2. The apparatus of claim 1, wherein
the privilege granting unit grants, as a privilege, a discount rate of a purchase amount for the purchase of the purchase-desired commodities, and
the privilege display unit displays, as information concerning the privilege, a purchase amount after discount of the purchase-desired commodities.

3. The apparatus of claim 1, further comprising:
a returned-commodity specifying unit configured to specify a commodity to be returned out of the purchase-desired commodities specified by the commodity specifying unit;
a commodity return processing unit configured to subtract, when the commodity to be returned is specified out of the purchase-desired commodities by the returned-commodity specifying unit, a number of items and an amount equivalent to the returned commodity from a number of purchase-planned items and a purchase-planned amount of the commodity in the purchase file; and
a privilege cancelling unit configured to cancel the privilege granted to the purchase of the purchase-desired commodities when, as a result of the subtraction processing by the commodity return processing unit, both the total of the total number of purchased items of the purchase-desired commodities obtained from the purchase-results storing unit and the numbers of purchase-planned items of the same commodities stored in the purchase file and the total of the total amount of purchased items of the purchase-desired commodities obtained from the purchase-results storing unit and the purchase-planned amounts of the commodities stored in the purchase file are smaller than the threshold.

4. The apparatus of claim 1, further comprising a shortage calculating unit configured to calculate a number of items needed for the total of the total number of purchased items of the purchase-desired commodities obtained from the purchase-results storing unit and the numbers of purchase-planned items of the same commodities stored in the purchase file to reach the threshold and an amount needed for the total of the total amount of purchased items of the purchase-desired commodities obtained from the purchase-results storing unit and the purchase-planned amounts of the commodities stored in the purchase file to reach the threshold, wherein
the privilege display unit displays the number of items or the amount needed to grant the privilege calculated by the shortage calculating unit.

5. The apparatus of claim 4, further comprising:
a returned-commodity specifying unit configured to specify a commodity to be returned out of the purchase-desired commodities specified by the commodity specifying unit;
a commodity return processing unit configured to subtract, when the commodity to be returned is specified out of the purchase-desired commodities by the returned-commodity specifying unit, a number of items and an amount equivalent to the returned commodity from a number of items and an amount of the commodity in the purchase file; and
a privilege cancelling unit configured to cancel the privilege granted to the purchase of the purchase-desired commodities when, as a result of the subtraction processing by the commodity return processing unit, both the total of the total number of purchased items of the purchase-desired commodities obtained from the purchase-results storing unit and the numbers of purchase-planned items of the same commodities stored in the purchase file and the total of the total amount of purchased items of the purchase-desired commodities obtained from the purchase-results storing unit and the purchase-planned amounts of the commodities stored in the purchase file are smaller than the threshold.

6. The apparatus of claim 1, wherein the privilege granting unit grants the privilege to the purchase of the purchase-desired commodities when the total number of purchased items of the purchase-desired commodities obtained from the purchase-results storing unit or the total amount of purchased items of the purchase-desired commodities obtained from the purchase-results storing unit is equal to or larger than the threshold and, when both the total number of purchased items and the total amount of purchased items are smaller than threshold, grants another privilege when the total of the total number of purchased items and the numbers of purchase-planned items of the same commodities stored in the purchase file or the total of the total amount of purchased items and the purchase-planned amounts of the same commodities stored in the purchase file coincides with the threshold.

7. The apparatus of claim 6, wherein the other privilege is issue information of a service ticket that can be used in next shopping.

8. The apparatus of claim 6, further comprising a shortage calculating unit configured to calculate a number of items needed for the total of the total number of purchased items of the purchase-desired commodities obtained from the purchase-results storing unit and the numbers of purchase-planned items of the same commodities stored in the purchase file to reach the threshold and an amount needed for the total of the total amount of purchased items of the purchase-desired commodities obtained from the purchase-results storing unit and the purchase-planned amounts of the commodities stored in the purchase file to reach the threshold, wherein
the privilege display unit displays the number of items or the amount needed to grant the privilege calculated by the shortage calculating unit.

9. A shopping supporting method for supporting shopping using a portable apparatus comprising:
specifying commodities that a customer desires to purchase;
storing, by commodity, as information concerning the specified purchase-desired commodities, at least numbers of purchase-planned items and purchase-planned amounts of the commodities;
granting a privilege to the purchase of the purchase-desired commodities when a total of a total number of purchased items of the purchase-desired commodities obtained from a purchase-results storing unit, which stores information concerning commodities already purchased by the customer, and numbers of purchase-planned items of same commodities stored in the purchase file or a total of a total amount of purchased items of the purchase-desired commodities obtained from the purchase-results storing unit and purchase-planned amounts of the same commodities stored in the purchase file is equal to or larger than a threshold;
displaying information concerning the granted privilege; and
outputting the information concerning the purchase-desired commodities stored in the purchase file and the information concerning the granted privilege.

10. A shopping supporting method for supporting shopping using a portable apparatus comprising:
specifying commodities that a customer desires to purchase;
storing, by commodity, as information concerning the specified purchase-desired commodities, at least numbers of purchase-planned items and purchase-planned amounts of the commodities;
granting the privilege to the purchase of the purchase-desired commodities when a total number of purchased items of the purchase-desired commodities obtained from a purchase-results storing unit, which stores information concerning commodities already purchased by the customer, or a total amount of purchased items of the purchase-desired commodities obtained from the purchase-results storing unit is equal to or larger than a threshold;
when both the total number of purchased items and the total amount of purchased items are smaller than threshold, granting another privilege when a total of the total number of purchased items and numbers of purchase-planned items of same commodities stored in the purchase file or a total of the total amount of purchased items and purchase-planned amounts of the same commodities stored in the purchase file coincides with the threshold;
displaying information concerning the granted privilege; and
outputting the information concerning the purchase-desired commodities stored in the purchase file and the information concerning the granted privilege.
